(19) United States
(12) Patent Application Publication
(10) Pub. No.: US 2025/0207752 A1
(43) Pub. Date: Jun. 26, 2025

(54) CONTROL SYSTEM AND METHOD FOR VEHICLE LIGHTING ARRANGEMENT

(71) Applicant: JAGUAR LAND ROVER LIMITED, Whitley, Coventry, Warwickshire (GB)

(72) Inventors: David PETTINGER, Whitley, Coventry, Warwickshire (GB); Victoria SHARPE, Whitley, Coventry, Warwickshire (GB)

(21) Appl. No.: 18/849,952

(22) PCT Filed: Mar. 22, 2023
(86) PCT No.: PCT/EP2023/057387

§ 371 Date: Sep. 23, 2024

(30) Foreign Application Priority Data
Mar. 24, 2022 (GB) 2204186.7

(51) Int. Cl. F21S 43/14; B60Q 1/38; B60Q 1/46; B60Q 1/50; B60W 30/18; F21W 103/30

(52) U.S. Cl. CPC F21S 43/14; B60Q 1/38; B60Q 1/46; B60Q 1/544; B60W 30/18163; F21W 2103/30

(57) ABSTRACT

A control system for a vehicle lighting arrangement comprises one or more controllers configured to receive a hazard signal indicative that the vehicle is under a hazard condition; control lighting elements to provide strobing illumination in dependence on the hazard signal; and in dependence on a determination that the vehicle is to perform an intended lane change while under the hazard condition, output a control signal to spatially animate the illumination provided by a first subset of the lighting elements such that a location of the illumination of the first subset moves to indicate a direction of the intended lane change; and control a second subset of the lighting elements to continue to provide strobing illumination such that the lighting arrangement concurrently indicates the direction of the intended lane change and the hazard condition.

### TECHNICAL FIELD

The present disclosure relates to control of vehicle lighting, in particular for use when the vehicle is under a hazard condition. Aspects of the invention relate to a control system, to a lighting system, to a vehicle, to a method and to a computer-readable medium.

### BACKGROUND

Conventional vehicle lighting arrangements disposed about an exterior of a vehicle comprise a set of lane change indicators, which may be strobed or otherwise illuminated to provide an indication to surrounding traffic that the vehicle intends to change lane or turn in the indicated direction. These lane change indicators may also be used as hazard strobe lights when the vehicle is in a hazardous condition, such as broken down on a hard shoulder, to indicate the hazard condition to surrounding traffic.

As vehicles move towards higher levels of autonomy, it may be possible for a vehicle to detect a hazardous condition whilst the vehicle is in motion. A hazardous condition may be detected, for example, if it is deemed necessary for the driver of the vehicle to take back control of the vehicle, but the driver of the vehicle is determined to be incapacitated. In such a situation, the vehicle may need to autonomously achieve a minimum risk condition to halt in a safe area, for example a hard shoulder. Achieving such a condition may require the vehicle to turn or change lanes. A problem may arise when using conventional control of vehicle lighting arrangements in that there is no capability to simultaneously indicate a hazard condition and an intent to change lane.

It is an aim of the present invention to address one or more of the disadvantages associated with the prior art.

### SUMMARY OF THE INVENTION

Aspects and embodiments of the invention provide a control system, a vehicle, and a computer-implemented method as claimed in the appended claims.

According to an aspect of the invention there is provided a control system for a vehicle lighting arrangement comprising a plurality of vehicle lighting elements disposed about an exterior of a vehicle; the control system comprising one or more controllers, the one or more controller configured to: receive a hazard signal indicative that the vehicle is under a hazard condition; control at least some of the plurality of lighting elements to provide strobing illumination in dependence on the hazard signal; and in dependence on a determination that the vehicle is to perform an intended lane change whilst under the hazard condition, output a control signal to: spatially animate the illumination provided by a first subset of the lighting elements such that a location of the illumination of the first subset moves to indicate a direction of the intended lane change, and control a second subset of the lighting elements to continue to provide strobing illumination such that the lighting arrangement concurrently indicates the direction of the intended lane change and the hazard condition.

According to an aspect of the invention there is provided a control system for a vehicle lighting arrangement comprising a plurality of vehicle lighting elements disposed about an exterior of a vehicle; the control system comprising one or more controllers, the one or more controller configured to: receive a hazard signal indicative that the vehicle is under a hazard condition; control the plurality of lighting elements to provide strobing illumination in dependence on the hazard signal; and in dependence on a determination that the vehicle is to perform an intended lane change whilst under the hazard condition, output a control signal to: spatially animate the illumination provided by a first subset of the lighting elements such that a location of the illumination of the first subset moves to indicate a direction of the intended lane change, and control a second subset of the lighting elements to continue to provide strobing illumination such that the lighting arrangement concurrently indicates the direction of the intended lane change and the hazard condition. Advantageously, as a portion of the lighting elements used to indicate the hazard are animated to indicate the direction, a hazard and a direction of an intended lane change can be simultaneously and clearly indicated to surrounding traffic without necessitating additional dedicated lighting units. The spatial animation may comprise asynchronously and progressively illuminating the first subset of lighting elements. The progression may be in the direction of the intended lane change. Thus, the spatial animation may cause illumination to move across the first subset of lighting elements on the vehicle in the direction of the intended travel.

Optionally, the one or more controller are configured to determine the first subset and the second subset of the lighting elements in dependence on the direction of the intended lane change. Thus, different lighting elements may be animated depending on the direction of the intended lane change. This may advantageously provide additional visual information to surrounding traffic regarding the direction. Optionally, the one or more controller are configured to determine the first subset to be a plurality of lighting elements disposed on a first side of the vehicle in dependence on the direction of the intended lane change being a first direction and determine the first subset to be a plurality of lighting elements disposed on a second side of the vehicle in dependence on the direction of the intended lane change being a second direction. The first side may be a side of vehicle towards the first direction when the vehicle is aligned in a lane, and the second side may be a side of vehicle towards the second direction when the vehicle is aligned in a lane. At least some of the first subset and second subset may be disposed on a rear of the vehicle.

Optionally, the first subset of lighting elements comprises an array of lighting elements, and the one or more controller are configured to output the control signal to spatially animate the array such that a location of the illumination of the first subset moves across the array in the direction of the intended lane change.

Optionally, the one or more controller are configured to receive the hazard signal from a driver condition monitoring system, wherein the hazard signal is indicative of a determination by the driver condition monitoring system that the driver is incapacitated.

Optionally, the one or more controller are configured to identify a target location of a minimum risk manoeuvre in dependence on a current location of the vehicle and determine the direction of the intended lane change in dependence on the target location. For example, the target location may be a nearest emergency area or hard shoulder. The one or more controller may be configured to control the vehicle to perform the minimum risk manoeuvre comprising the intended lane change towards the target location whilst the lighting arrangement concurrently indicates the direction of the intended lane change and the hazard condition.

The one or more controller may comprise: an electrical input for receiving an electrical signal indicative of the hazard signal, an electrical output for outputting a control signal for controlling the plurality of lighting elements, and one or more electronic processors for operatively executing computer-readable instructions to determine the control signal to: control the plurality of lighting elements to provide strobing illumination in dependence on the hazard signal; in dependence on a determination that the vehicle is to perform an intended lane change whilst under the hazard condition, spatially animate the illumination provided by a first subset of the lighting elements such that a location of the illumination of the first subset moves to indicate a direction of the intended lane change, and control a second subset of the lighting elements to continue to provide strobing illumination such that the lighting arrangement concurrently indicates the direction of the intended lane change and the hazard condition.

According to another aspect there is provided a lighting system for a vehicle, comprising: a vehicle lighting arrangement comprising a plurality of vehicle lighting elements disposed, in use, around an exterior of the vehicle, the plurality of vehicle lighting elements comprising a first subset of lighting elements and a second subset of lighting elements; and the control system for controlling the vehicle lighting arrangement according to the above aspect.

Optionally, the plurality of vehicle lighting elements comprise a plurality of lane change indicator lights of the vehicle. The first subset of lighting elements may comprise a first lane change indicator of the vehicle and the second subset of lighting elements may comprise a second lane change indicator of the vehicle. Each of the first subset and second subset of lighting elements may comprise an array of LEDs. The first lane change indicator may be disposed on a side of the vehicle towards the direction of the intended lane change. The first indicator and second indicator may both be at least partially disposed on a rear of the vehicle.

Optionally, the first subset of lighting elements comprises a first portion of a first lane change indicator of the vehicle, and the second subset of lighting elements comprises a second portion of the first lane change indicator of the vehicle. In this way, a single lane change indicator may simultaneously indicate a hazard condition and a direction.

According to another aspect, there is provided a vehicle comprising a control system according to the aspect above or a lighting system according to the aspect above.

According to another aspect, there is provided a computer-implemented method for controlling a vehicle lighting arrangement comprising a plurality of vehicle lighting elements disposed about an exterior of a vehicle, the method comprising: receiving a hazard signal indicative that the vehicle is under a hazard condition; controlling the plurality of lighting elements to provide strobing illumination in dependence on the hazard signal; and determining that the vehicle is to perform an intended lane change whilst under the hazard condition, and in dependence on the determination: spatially animating the illumination provided by a first subset of the lighting elements such that a location of the illumination of the first subset moves to indicate a direction of the intended lane change, and controlling a second subset of the lighting elements to continue to provide strobing illumination such that the lighting arrangement concurrently indicates the direction of the intended lane change and the hazard condition.

The spatial animation may comprise progressively illuminating the first subset of lighting elements. The progression may be in a direction of the intended lane change. The spatial animation may cause illumination to move across first subset of lighting elements on the vehicle in the direction of the intended travel.

The method may comprise determining the first subset and the second subset of the lighting elements in dependence on the direction of the intended lane change. The method may comprise determining the first subset to be a plurality of lighting elements disposed on a first side of the vehicle in dependence on the direction of the intended lane change being a first direction and determining the first subset to be a plurality of lighting elements disposed on a second side of the vehicle in dependence on the direction of the intended lane change being a second direction. The first side may be a side of the vehicle towards the first direction when the vehicle is aligned in a lane, and the second side may be a side of the vehicle towards the second direction when the vehicle is aligned in a lane. At least some of the first subset and second subset may be disposed on a rear of vehicle.

Optionally, the first subset of lighting elements comprises an array of lighting elements, and the method comprises spatially animating the array such that a location of the illumination of the first subset moves across the array in the direction of the intended lane change.

The method may comprise receiving the hazard signal from a driver condition monitoring system, wherein the hazard signal is indicative of a determination by the driver condition monitoring system that the driver is incapacitated.

The method may comprise identifying a target location of a minimum risk manoeuvre in dependence on a current location of the vehicle and determining the direction of the intended lane change in dependence on the target location. The target location may be a nearest emergency area or hard shoulder. The method may comprise controlling the vehicle to perform the minimum risk manoeuvre comprising the intended lane change towards the target location whilst the lighting arrangement concurrently indicates the direction of the intended lane change and the hazard condition.

According to another aspect, there is provided a computer-readable medium comprising computer software which, when executed, causes the performance of the method above.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a lighting system according to the present invention;

FIG. 2 shows a vehicle including the lighting system according to an embodiment;

FIG. 3A shows a lighting unit of the vehicle according to an embodiment;

FIG. 3B illustrates an animated indication on the lighting unit according to an embodiment;

FIGS. 4A to 4C illustrate arrangements of a first subset and a second subset of lighting elements on a vehicle according to embodiments;

FIG. 5 illustrates a flow chart showing a method according to an embodiment; and

FIG. 6 shows a schematic illustration of a control system according to an embodiment.

### DETAILED DESCRIPTION

A control system 110 in accordance with an embodiment of the present invention will now be described with reference to the accompanying figures. The control system 110 is for controlling a vehicle lighting arrangement about an exterior of a vehicle, in particular to facilitate concurrent indication of an intended lane change and a hazard condition.

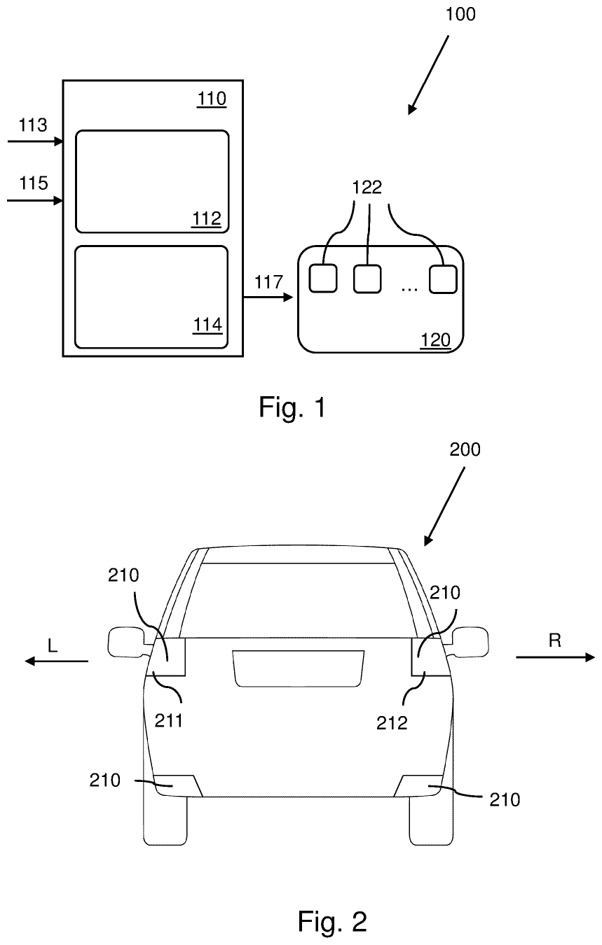

As shown in FIG. 1, according to an embodiment there is provided a lighting system 100 comprising the control system 110 and a vehicle lighting arrangement 120. The control system 110 comprises processing means 112 and memory means 114. The processing means 112 may be one or more electronic processing devices. The memory means 114 may be one or more memory devices. The memory means 114 is electrically coupled to the processing means 112. The memory means 114 is configured to store instructions, and the processing means 112 is configured to access the memory means and execute the instructions thereon.

The vehicle lighting arrangement 120 comprises a plurality of vehicle lighting elements 122. Each vehicle lighting element 122 may be any type of light emitting element, for example a light emitting diode (LED) or any other form of controlled radiated light such as a laser or other candescent bulb.

With reference to FIG. 2, the vehicle lighting elements 122 may be arranged about an exterior of a vehicle 200. The vehicle 200 in the present embodiment is an automobile, such as a wheeled vehicle, but it will be understood that the lighting system 100 may be used in other types of vehicle.

The vehicle 200 comprises a plurality of lighting units 210. Each lighting unit 210 is arranged at a respective location on the exterior of the vehicle 200 for providing a respective lighting functionality. For example, the plurality of lighting units 210 may comprise one or more lane change indicators, brake lights, side lights, taillights and/or headlights and the like. The plurality of lighting units 210 may be arranged on one or more of a front of the vehicle, a rear of the vehicle or either side of the vehicle. It will be appreciated that the lighting units 210 may be arranged in any suitable manner depending on the type and style of vehicle 200. Each lighting unit 210 may comprise one or more of the vehicle lighting elements 122. For example, each lighting unit 210 may be formed as an array of the vehicle lighting elements 122.

The plurality of lighting units 210 may comprise at least a first lane change indicator 211 disposed toward a first side of the vehicle 200 and a second lane change indicator 212 disposed toward a second side of the vehicle 200. In the embodiment shown in FIG. 2, the first and second lane change indicators 211, 212 are disposed on a rear of the vehicle 200, however it will be appreciated that in other embodiments the first and second lane change indicators 211, 212 may be disposed on a front of the vehicle 200 and/or a side of the vehicle 200. Typically, the first lane change indicator 211 may be illuminated to indicate an intended lane change or turn by the vehicle 200 in a first direction L extending from the first side of the vehicle and the second lane change indicator 212 may be illuminated to indicate an intended lane change or turn by the vehicle 200 in a second direction R extending from the second side of the vehicle. Both the first and second lane change indicators 211, 212 may also be illuminated, for example in a strobing pattern, to indicate a hazard condition. Thus, when both lane change indicators 211, 212 are being used to indicate a hazard condition, it may not be possible to indicate an intended lane change. Conventionally, this may not always be problematic as typically the hazard lights will only be switched on when the vehicle has broken down or otherwise come to a stop and thus the driver does not require use of the lane change indicators to signal a lane change or turn. However, as vehicles operate with higher levels of autonomy, the vehicle may be equipped with various monitoring systems for detecting when there is a need to transition control back to a driver. If the driver is deemed to be incapacitated, the vehicle may be required to perform a minimum risk manoeuvre to come to a halt at a safe space, such as a motorway hard shoulder. It may then be necessary to indicate to surrounding traffic that the vehicle is in a hazardous state, due to the incapacitation of the driver, and simultaneously indicate a required lane change to make the minimum risk manoeuvre safely. Thus, there may be a need to utilise the lighting units 210 to concurrently indicate a hazard condition and a direction.

To facilitate such concurrent indication, the control system 110 is configured to control the lighting elements 122 of at least some of the lighting units 210 to transition between a static hazard indication and an animated direction indication.

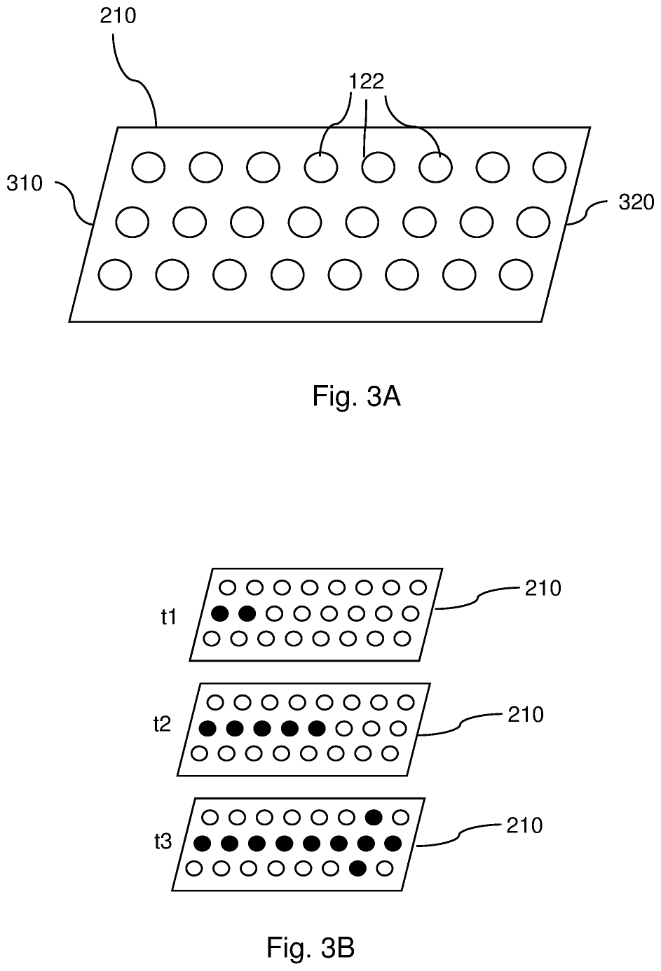

With reference to FIG. 3A, there is shown an example lighting unit 210 comprising an array of the vehicle lighting elements 122. The lighting unit 210 shown in FIG. 3 may be one of the lane change indicators 211, 212.

The lighting unit 210 may be controlled to perform either a static indication or an animated indication. The lighting unit 210 may perform a static indication by illuminating each of the lighting elements 122 concurrently. Typically, a static indication is provided as a strobing pattern, such that each lighting element 122 in the array is illuminated in an on/off cycle having a predetermined periodicity. To provide a static indication, the on/off cycle of each lighting clement 122 is synchronised such that the lighting unit 210 is illuminated and switched off as a block.

To provide an animated indication, which may also be referenced as a dynamic indication, the lighting elements 122 of the lighting unit 210 are illuminated asynchronously to provide a spatial animation. The spatial animation may be provided by causing a location of the illumination within the array to move across the array to indicate a direction. For example, the lighting unit 210 may provide an animated indication of a first direction by progressively illuminating the lighting elements 122 from a first side 310 of the lighting unit 210 to a second side 320 of the lighting unit 210. Conversely, an opposite second direction may be indicated by progressively illuminating the lighting elements from the second side 320 to the first side 310.

An example of an animated indication provided by the lighting unit 210 is shown in FIG. 3B. Illuminated elements are indicated as solid blocks. The lighting unit 210 is illustrated at three sequential time points t1, t2, t3 within one period of indication. As shown, a mean location of the illuminated elements progresses across the lighting unit 210 from a first side towards a second side of the lighting unit throughout the period. In the illustrated example, the illuminated lighting elements are arranged in an arrow shape which can provide additional directional information to that provided by the animation, however it will be appreciated that this arrangement is optional. For example, in other embodiments all the displayed lighting elements may be progressively illuminated in an analogous manner.

With reference again to FIG. 1, the control system 110 is configured to receive a hazard signal 113 indicative that the vehicle is under a hazard condition. The hazard signal 113 may be received in some embodiments in dependence on a user input at a user interface associated with the vehicle. For example, a driver of the vehicle may manually determine the presence of a hazard and make a selection at the user interface to indicate the presence of a hazard, for example by making a touch input, voice input or the like. In other embodiments, the hazard signal 113 may be received from a driver condition monitoring system. The driver condition monitoring system may be arranged to determine whether a driver of the vehicle is incapacitated, and the hazard signal 113 may be indicative of a determination that the driver is incapacitated.

The control system 110 is configured to output a control signal 117 to control at least some of the plurality of lighting elements 122 to provide strobing illumination in dependence on the hazard signal 113. Thus, each lighting unit 210 may be controlled to provide a static indication in order to indicate the hazard. The strobing illumination is static, that is the lighting elements 122 of each lighting unit are illuminated concurrently in an on/off cycle having a predetermined periodicity. The on/off cycle of each lighting element 122 is synchronised such that each lighting unit 210 is illuminated and switched off as a block. As discussed, the lighting units 210 may include the lane change indicators 211, 212. The lighting units 210 may also include further vehicle lighting units such as headlights, taillights, sidelights, or the like. Thus, at least some of the lighting units 210 arranged about the exterior of the vehicle are arranged to provide a static strobing illumination to indicate to surrounding traffic that the vehicle is under a hazard condition.

Whilst the lighting elements 122 are providing strobing illumination to indicate a hazard condition, it may be determined that the vehicle is to perform an intended lane change. This may occur, for example, if the vehicle is travelling on an inner lane of a multi-lane highway and due to the incapacitated driver, needs to perform a minimum risk manoeuvre to reach a stop on a safe space such as a hard shoulder. It may be determined that the vehicle is to perform an intended lane change multiple times within the minimum risk manoeuvre. For example, a first lane change may be determined between a first lane and a second lane. A second lane change may be determined between the second lane and the hard shoulder. Each lane change may be treated independently by the control system 110. The control system 110 may thus be configured to receive a lane change signal 115 indicative of a direction of an intended lane change.

In response to the lane change signal 115, the control system 110 is configured to control a first subset of the lighting elements 122 to transition from a static to an animated indication. In this way, the animated indication may be used to effectively indicate a direction of the intended lane change, whilst the remainder of the lighting elements 122 continue to provide static strobing illumination to indicate the hazard.

In particular, the control system 110 is configured to spatially animate the illumination provided by the first subset of the lighting elements 122 such that a location of the illumination of the first subset of lighting elements moves to indicate the direction of the intended lane change, such as illustrated in FIG. 3B. That is, the first subset of lighting elements may be progressively illuminated in the direction of the intended lane change. A second subset of the lighting elements is controlled to continue to provide the strobing illumination, such that the lighting arrangement 120 concurrently indicates the direction of the intended lane change (via the animated indication of the first subset) and the hazard condition (via the static strobing illumination of the second subset).

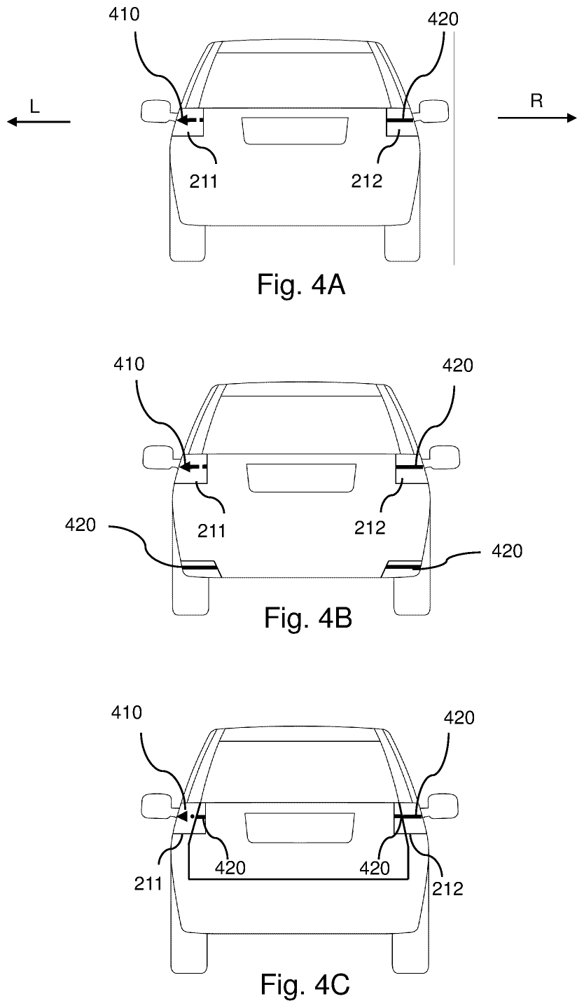

With reference to FIGS. 4A to 4C, there is shown example arrangements of a first subset 410 and a second subset 420 of lighting elements according to some embodiments.

As shown in FIGS. 4A and 4B according to some embodiments the first subset 410 of lighting elements may be arranged within one of the lane change indicators 211, 212. In the illustrated embodiments, the first subset 410 is arranged within the first lane change indicator 211, however it will be appreciated that in other embodiments the first subset 410 may be arranged within a different lighting unit such as the second lane change indicator 212. The second subset 420 of lighting elements may thus be arranged across the remaining lighting units 210. In the embodiment of FIG. 4A, at least some of the second subset 420 of lighting elements are arranged within the second lane change indicator 420. In FIG. 4B, it can be seen that the second subset 420 may additionally extend across further vehicle lighting units 210 such as taillights or fog lamps of the vehicle, for example.

According to some embodiments, the first subset 410 and the second subset 420 of lighting elements may be selected by the control system 110 in dependence on the direction of the intended lane change. The first subset 410 may be determined to correspond to a lighting unit 210 on a first side of the vehicle in dependence on the direction of the intended lane change being a first direction and correspond to a lighting unit 210 on a second side of the vehicle in dependence on the direction of the intended lane change being a second direction. For example, as shown in FIG. 4A, if the direction of the intended lane change is a first direction L, the control system 110 may determine the first subset 410 to correspond to the first lane change indicator 211, as shown. Conversely, if the direction of the intended lane change is a second direction R, the control system 110 may determine the first subset 410 to correspond to the second lane change indicator 212.

In other embodiments, the same first subset 410 may be selected irrespective of the direction of the intended lane change. This is possible as the direction of the intended lane change is represented to the surrounding traffic by the direction of the animation, as explained.

With reference to FIG. 4C, it can be seen that in some embodiments, the first subset 410 may comprise only a portion of the lighting elements of a given lighting unit 210. In the example shown, the lane change indicators 211, 212 are segregated and only one portion of the first lane change indicator 211 forms part of the first subset 410 for providing the animated indication. The other portion of the first lane change indicator 211 forms part of the second subset 420 for continuing to provide strobing illumination. It will be appreciated that any lighting unit 210 formed as an array of lighting elements may be functionally split in an analogous way, such that a single lighting unit 210 can be used to simultaneously provide two types of indication.

Although the embodiments illustrated in FIGS. 2 and 4A to 4C show only lighting units on a rear of a vehicle, it will be appreciated that the present invention may be applied to any arrangement of lighting units, including lighting units on a front of the vehicle or on a side of the vehicle. Providing both the first subset 410 and second subset 420 at least in part on the rear of the vehicle may be advantageous in a multi-lane highway situation wherein the surrounding traffic is likely to be approaching the vehicle from the rear. However, in other situations it may additionally or alternatively beneficial to provide some of the first subset 410 and second subset 420 of lighting elements on the front of the vehicle.

According to the present invention, use of an animated indication and a strobing indication concurrently allows the simultaneous indication of a hazard condition and a lane change direction. Use of a portion of the lighting arrangement to provide the animated indication for the lane change facilitates accurate identification of the indicated direction, even when surrounding lighting units in the lighting arrangement are providing strobing hazard illumination. Furthermore, no additional lighting units need to be provided as a portion of the lighting units used for the hazard illumination may be utilised to provide the direction indication. This is possible due to the distinct static and animated illumination types, which may both be readily implemented by a standard vehicle lighting unit such as an LED array. The lack of necessity for any further lighting units provides the benefit of weight reduction in the vehicle, improving the efficiency and hence range of the vehicle. This may be particularly beneficial in electric vehicles (EVs) having limited range.

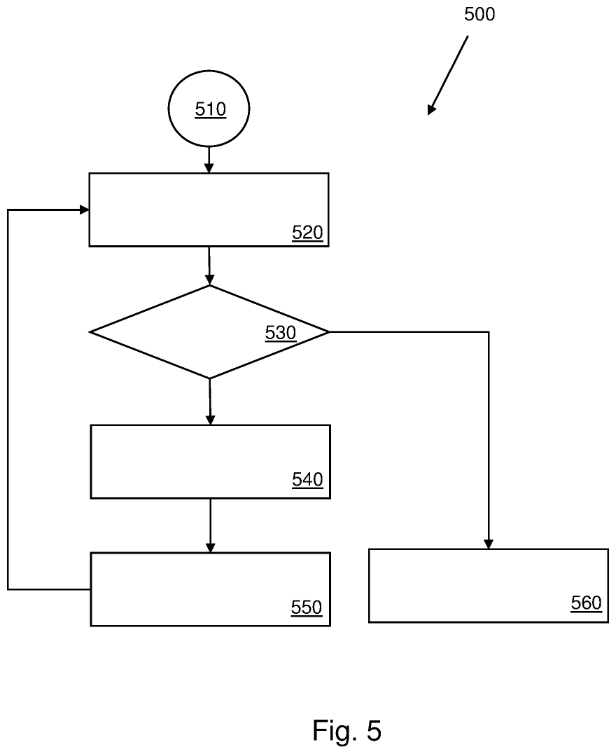

A method 500 of operation of the lighting system 100 according to an embodiment of the invention is illustrated in FIG. 5. At least some of the steps of the method 500 may be performed by the control system 110. The method 500 may be performed during autonomous or semi-autonomous operation of the vehicle in order to bring the vehicle to a stop in an emergency situation.

In block 510, the method 500 monitors a state of a driver of the vehicle and determines whether the driver is incapacitated. The monitoring may be performed by a driver condition monitoring system associated with the vehicle. The monitoring may comprise receiving image data, biometric data and the like associated with a driver of the vehicle and determining whether the driver is incapacitated in dependence on the received data. The received data may also or additionally include vehicle sensor data, for example indicative of a frequency and/or a magnitude of rotation applied at a steering wheel of the vehicle. If the driver is determined to be incapacitated, the method proceeds to block 520.

In block 520, the plurality of lighting elements 122 are controlled to provide strobing illumination to indicate that the vehicle is under a hazard condition. To provide the strobing illumination, each lighting element 122 is illuminated in an on/off cycle having a predetermined periodicity, and the on/off cycle of each lighting element 122 is synchronised such that all of the lighting units 210 associated with the lighting system 100 are illuminated and switched off concurrently.

In block 530, it is determined whether the vehicle needs to perform a minimum risk manoeuvre including a lane change in order to achieve a minimum risk condition. The minimum risk condition may be defined as locating the vehicle at a target safe stopping position such as an emergency area or hard shoulder. If the vehicle needs to perform a minimum risk manoeuvre, the method proceeds to block 540. In block 540 a direction of the intended lane change is determined in dependence on the target location, and the illumination provided by a first subset of the lighting elements is spatially animated such that a location of the illumination of the first subset moves to indicate a direction of the intended lane change, such as shown in FIG. 3B. A second subset of the lighting elements is controlled to continue to provide the strobing illumination defined in block 520. In this way, the lighting arrangement is controlled to concurrently indicate the direction of the intended lane change and the hazard condition.

In block 550, the vehicle is controlled to perform the minimum risk manoeuvre comprising the intended lane change towards the target location whilst the lighting arrangement concurrently indicates the direction of the intended lane change and the hazard condition.

After the manoeuvre has been performed, the method returns to block 520 and the plurality of lighting elements 122 are controlled to provide the strobing illumination to indicate that the vehicle is under a hazard condition. That is, the plurality of lighting elements 122 arc controlled to again provide only an indication of hazard without the indication of direction. In block 530, it is determined whether a further manoeuvre is required, for example a further lane change. If so, blocks 540 and 550 are repeated for the further lane change. The method may be repeated in this manner for any number of iterations required to perform all manoeuvres to achieve the minimum risk condition, for example twice if two lane changes are required.

Once it is determined that no further manoeuvre is required, the method proceeds to block 560 and the vehicle is brought to a stop at the target location.

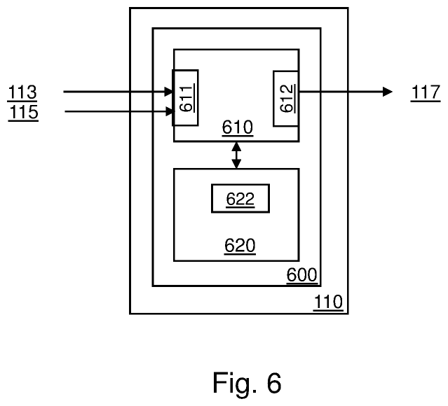

With reference to FIG. 6, there is illustrated a simplified example of a control system 110 such as may be adapted to implement the method described herein. The control system 110 comprises one or more controllers 600 and is configured to control the lighting arrangement 120.

It is to be understood that the or each controller 600 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 600 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 600 to implement the control techniques described herein (including some or all of the functionality required for the method described herein). The set of instructions could be embedded in said one or more electronic processors of the controller 600; or alternatively, the set of instructions could be provided as software to be executed in the controller 600. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 6, the or each controller 600 comprises at least one electronic processor 610 having one or more electrical input(s) 611 for receiving one or more input signals such as the signals 113, 115, and one or more electrical output(s) 612 for outputting one or more output signals such as the control signal 117. The or each controller 600 further comprises at least one memory device 620 electrically coupled to the at least one electronic processor 610 and having instructions 622 stored therein. The at least one electronic processor 610 is configured to access the at least one memory device 620 and execute the instructions 622 thereon.

The, or each, electronic processor 610 may comprise any suitable electronic processor (e.g., a microprocessor, a microcontroller, an ASIC, etc.) that is configured to execute electronic instructions. The, or each, electronic memory device 620 may comprise any suitable memory device and may store a variety of data, information, threshold value(s), lookup tables or other data structures, and/or instructions therein or thereon. In an embodiment, the memory device 620 has information and instructions for software, firmware, programs, algorithms, scripts, applications, etc. stored therein or thereon that may govern all or part of the methodology described herein. The processor, or each, electronic processor 610 may access the memory device 620 and execute and/or use that or those instructions and information to carry out or perform some or all of the functionality and methodology describe herein.

The at least one memory device 620 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 600 have been described comprising at least one electronic processor 610 configured to execute electronic instructions stored within at least one memory device 620, which when executed causes the electronic processor(s) 610 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

1. A control system for a vehicle lighting arrangement comprising a plurality of vehicle lighting elements disposed about an exterior of a vehicle; the control system comprising one or more controllers, the one or more controllers configured to:
receive a hazard signal indicative that the vehicle is under a hazard condition;
control the plurality of vehicle lighting elements to provide strobing illumination in dependence on the hazard signal; and
in dependence on a determination that the vehicle is to perform an intended lane change while under the hazard condition, output a control signal to:
spatially animate illumination provided by a first subset of the plurality of vehicle lighting elements such that a location of the illumination of the first subset moves to indicate a direction of the intended lane change,
and control a second subset of the plurality of vehicle lighting elements to continue to provide strobing illumination such that the lighting arrangement concurrently indicates the direction of the intended lane change and the hazard condition.

2. The control system of claim 1, wherein the one or more controllers are configured to determine the first subset and the second subset of the plurality of vehicle lighting elements in dependence on the direction of the intended lane change.

3. The control system of claim 2, wherein the one or more controllers are configured to determine the first subset to be a plurality of lighting elements disposed on a first side of the vehicle in dependence on the direction of the intended lane change being a first direction and determine the first subset to be a plurality of lighting elements disposed on a second side of the vehicle in dependence on the direction of the intended lane change being a second direction.

4. The control system of claim 1, wherein the first subset of lighting elements comprises an array of lighting elements, and wherein the one or more controllers are configured to output the control signal to spatially animate the array such that a location of the illumination of the first subset moves across the array in the direction of the intended lane change.

5. The control system of claim 1, wherein the one or more controllers are configured to receive the hazard signal from a driver condition monitoring system, wherein the hazard signal is indicative of a determination by the driver condition monitoring system that a driver is incapacitated.

6. The control system of claim 1, wherein the one or more controllers are configured to identify a target location of a minimum risk maneuver in dependence on a current location of the vehicle and determine the direction of the intended lane change in dependence on the target location.

7. The control system of claim 6, wherein the one or more controllers are configured to control the vehicle to perform the minimum risk maneuver comprising the intended lane change towards the target location while the lighting arrangement concurrently indicates the direction of the intended lane change and the hazard condition.

8. The control system of claim 1, wherein the one or more controllers comprise:
an electrical input for receiving an electrical signal indicative of the hazard signal,
an electrical output for outputting a control signal for controlling the plurality of vehicle lighting elements, and
one or more electronic processors for operatively executing computer-readable instructions to determine the control signal to:
control the plurality of vehicle lighting elements to provide strobing illumination in dependence on the hazard signal;
in dependence on a determination that the vehicle is to perform an intended lane change whilst while under the hazard condition, spatially animate illumination provided by a first subset of the plurality of vehicle lighting elements such that a location of the illumination of the first subset moves to indicate a direction of the intended lane change,
and control a second subset of the plurality of vehicle lighting elements to continue to provide strobing illumination such that the lighting arrangement concurrently indicates the direction of the intended lane change and the hazard condition.

9. A lighting system for a vehicle, comprising:
a vehicle lighting arrangement comprising a plurality of vehicle lighting elements disposed, in use, around an exterior of the vehicle, the plurality of vehicle lighting elements comprising a first subset of lighting elements and a second subset of lighting elements; and
the control system for controlling the vehicle lighting arrangement according to any preceding claim 1.

10. The lighting system of claim 9, wherein the plurality of vehicle lighting elements comprise a plurality of lane change indicator lights of the vehicle.

11. The lighting system of claim 10, wherein the first subset of lighting elements comprises a first lane change indicator of the vehicle and wherein the second subset of lighting elements comprises a second lane change indicator of the vehicle.

12. The lighting system of claim 10, wherein the first subset of lighting elements comprises a first portion of a first lane change indicator of the vehicle, and the second subset of lighting elements comprises a second portion of the first lane change indicator of the vehicle.

13. A vehicle comprising the control system according to claim 1.

14. A computer-implemented method for controlling a vehicle lighting arrangement comprising a plurality of vehicle lighting elements disposed about an exterior of a vehicle, the computer-implemented method comprising:
receiving a hazard signal indicative that the vehicle is under a hazard condition;
controlling the plurality of vehicle lighting elements to provide strobing illumination in dependence on the hazard signal; and
determining that the vehicle is to perform an intended lane change while under the hazard condition, and in dependence on the determination:
spatially animating illumination provided by a first subset of the plurality of vehicle lighting elements such that a location of the illumination of the first subset moves to indicate a direction of the intended lane change,
and controlling a second subset of the plurality of vehicle lighting elements to continue to provide strobing illumination such that the lighting arrangement concurrently indicates the direction of the intended lane change and the hazard condition.

15. A computer-readable medium comprising computer software which, when executed, causes performance of the computer-implemented method of claim 14.

16. A vehicle comprising the lighting system according to claim 9.
